(19) United States
(12) Patent Application Publication
(10) Pub. No.: US 2022/0237465 A1
(43) Pub. Date: Jul. 28, 2022

(54) PERFORMING INFERENCE AND SIGNAL-TO-NOISE RATIO BASED PRUNING TO TRAIN SPARSE NEURAL NETWORK ARCHITECTURES

(71) Applicant: Numenta, Inc., Redwood City, CA (US)

(72) Inventors: Marcus Anthony Lewis, San Francisco, CA (US); Subutai Ahmad, Palo Alto, CA (US)

(21) Appl. No.: 17/235,516

(22) Filed: Apr. 20, 2021

Related U.S. Application Data
(60) Provisional application No. 63/141,753, filed on Jan. 26, 2021.

(51) Int. Cl. G06N 3/08; G06N 3/04; G06K 9/62

(52) U.S. Cl. CPC G06N 3/082; G06K 9/6261; G06N 3/0481; G06N 3/084

(57) ABSTRACT

A sparse neural network is trained such that weights or layer outputs of the neural network satisfy sparsity constraints. The sparsity is controlled by pruning one or more subsets of weights based on their signal-to-noise ratio (SNR). During the training process, an inference system generates outputs for a current layer by applying a set of weights for the current layer to a layer output of a previous layer. The set of weights for the current layer may be modeled as random variables sampled from probability distributions. The inference system determines a loss function and updates the set of weights by backpropagating error terms obtained from the loss function. This process is repeated until a convergence criterion is reached. One or more subsets of weights are then pruned based on their SNR depending on sparsity constraints for the weights of the neural network.

### CROSS-REFERENCE TO RELATED APPLICATION

This application claims priority to U.S. Provisional Patent Application No. 63/141,753 filed on Jan. 26, 2021, which is hereby incorporated by reference in its entirety.

### BACKGROUND

### 1. Field of the Disclosure

The present disclosure relates to a neural network for processing input data, and more specifically to training sparse weights for neural networks.

### 2. Description of the Related Arts

Machine-learned neural networks can be used to perform a wide variety of tasks, including inference and prediction, on input data. For example, a neural network can be used to perform object detection on whether content items such as images or videos contain objects-of-interest. As another example, a neural network can be used to predict likelihoods that users will interact with a content item, or predict the next one or more word tokens given previous word tokens in an electronic document.

A neural network may generally include a set of layers, each including one or more nodes. A layer output at nodes of a given layer is generated by applying a transformation to the layer output at nodes of a previous layer. Specifically, during the inference process, the layer output of the given layer is generated by applying a set of weights associated with the layer to the layer output of the previous layer. The set of weights represents connections between nodes of the given layer and nodes at the previous layer and are determined through a training process. The inference data can be generated by propagating the input data through the layers of the neural network.

### SUMMARY

Embodiments relate to training a sparse neural network such that weights or layer outputs of the neural network satisfy one or more sparsity constraints. The sparsity may be controlled by pruning one or more subsets of weights based on their signal-to-noise ratio (SNR). During the training process, an inference system generates outputs for a current layer by applying a set of weights for the current layer to a layer output of a previous layer. The set of weights for the current layer may be modeled as random variables sampled from probability distributions. The inference system determines a loss function and updates the set of weights by backpropagating error terms obtained from the loss function. This process is repeated until a convergence criterion is reached. One or more subsets of weights are then pruned based on their SNR depending on sparsity constraints for the weights of the neural network.

### BRIEF DESCRIPTION OF THE DRAWINGS

The teachings of the embodiments of the present invention can be readily understood by considering the following detailed description in conjunction with the accompanying drawings.

FIG. 1 is a conceptual diagram of an inference system, according to one embodiment.

FIG. 2 illustrates an example architecture of a sparse neural network, according to an embodiment.

FIGS. 3A-3C illustrate examples of weight tensors for the sparse neural network, according to embodiments.

FIG. 4 illustrates an example process for training a sparse neural network, according to an embodiment.

FIG. 5 illustrates modeling weights of a neural network as a product between a scalar tensor and random variables sampled from probability distributions defined by parameter tensors, according to an embodiment.

FIG. 6 is a graph illustrating a signal-to-noise ratio (SNR) for a weight modeled as a random variable sampled from a probability distribution, according to an embodiment.

FIG. 7 is a flowchart illustrating a method of training a sparse neural network, according to one embodiment.

FIG. 8 is a block diagram of a computing device for implementing inference systems, according to an embodiment.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure set forth herein is intended to be illustrative, but not limiting, of the scope, which is set forth in the claims.

Embodiments relate to training a sparse neural network such that the weights or layer outputs of the neural network satisfy one or more sparsity constraints. Such sparsity constraints may be imposed by a hardware accelerator for executing the neural network. Weights of the neural network are updated and pruned to control sparsity while maintaining inference accuracy of the neural network.

Specifically, a neural network may include one or more layers, and each layer may be associated with a set of weights that represent connections between nodes of a layer and nodes of a previous layer. During the training process, an inference system generates outputs for a current layer by applying a set of weights for a current layer to a layer output of a previous layer. The set of weights for the current layer may be modeled as random variables sampled from probability distributions. The inference system determines a loss function and updates the set of weights by backpropagating error terms obtained from the loss function. This process is repeated until a convergence criterion is reached. The sparsity is controlled by pruning one or more subsets of weights based on their signal-to-noise ratios (SNRs) that indicate a degree of contribution made by a weight to inference of the neural network.

When a weight is modeled as a random variable, the SNR of a weight indicates the level of a desired signal to the level of background noise that is inferred from the probability distribution of the weight. Thus, a weight with a high SNR indicates a high degree of contribution made by the weight to inference of the neural network, and a weight with a low SNR indicates that the weight is noisy, or has a low degree of contribution made to inference of the neural network. In one embodiment, when the weight is modeled as a Gaussian random variable, the SNR of the weight is given by the ration of the mean to the variance of the Gaussian distribution for the weight.

### High-Level Overview of Inference System

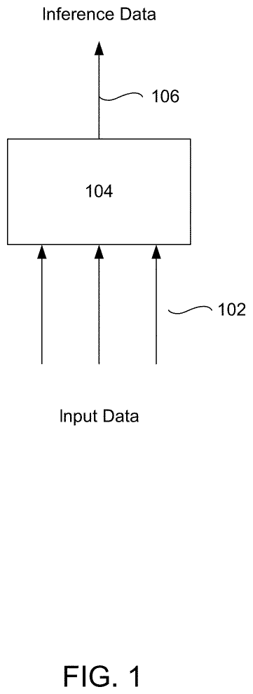

FIG. 1 is a conceptual diagram of an inference system 104, according to one embodiment. The inference system 104 performs inference and predictions on input data 102. In one particular embodiment referred throughout the remainder of the specification, the inference system 104 performs inference on input data 102, and generates inference data 106. For example, the inference system 104 may receive input data 102 corresponding to images of a road, and perform object recognition for pedestrians based on the received inputs. The inference data 106 may indicate locations of pedestrians in the image. As another example, the inference system 104 may receive input data 102 corresponding to input text in an electronic document, and the inference data 106 may indicate predictions for the next word tokens that are likely to come after the input text.

The input data 102 may include, among others, images, videos, audio signals, sensor signals (e.g., tactile sensor signals), data related to network traffic, financial transaction data, communication signals (e.g., emails, text messages, and instant messages), documents, insurance records, biometric information, parameters for manufacturing process (e.g., semiconductor fabrication parameters), inventory patterns, energy or power usage patterns, data representing genes, results of scientific experiments or parameters associated with operation of a machine (e.g., vehicle operation) and medical treatment data. The underlaying representation (e.g., photo, audio, etc.) can be stored in a non-transitory storage medium. In one embodiment, the input data 102 is encoded into a vector signal and fed to the inference system 104.

The inference system 104 may process the input data 102 to produce the inference data 106 representing, among others, identification of objects, identification of recognized gestures, classification of digital images as pornographic or non-pornographic, identification of email messages as unsolicited bulk email (“spam”) or legitimate email (“non-spam”), identification of a speaker in an audio recording, classification of loan applicants as good or bad credit risks, identification of network traffic as malicious or benign, identify of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, identification of anomalous patterns in insurance records, prediction on results of experiments, indication of an illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, and a summary of text or prediction on reaction to medical treatments.

The inference system 104 performs inference using a neural network that includes a set of layers of nodes, in which a layer output at nodes of a current layer are a transformation of the layer outputs at previous layers. Specifically, the layer output at nodes of the current layer may be generated by applying a set of weights to the layer output of the previous layers. The set of weights represent connections between nodes of the current layer and nodes at the previous layers and are learned through a training process. The inference data 106 is generated by propagating the input data 102 through the layers of the neural network.

In one embodiment described throughout the remainder of the specification, the set of weights for a current layer of a trained neural network may be represented by a weight tensor of any number of dimensions depending on the architecture of the neural network to be trained. For example, the set of weights for a current layer may be represented by a two-dimensional or three-dimensional weight tensor. Each weight in the weight tensor may be associated with a potential connection between a respective node in the current layer and a respective node in a previous layer, and thus, the set of elements in the weight tensor may represent all possible connections between the nodes of these layers. When a connection is not present, the respective weight has a zero value in the weight tensor.

Oftentimes, neural networks are executed on hardware accelerators that are efficient at performing certain machine-learning related operations, such as tensor multiplications, convolutions, or tensor dot products. A hardware accelerator may take the form of, for example, field-programmable gate arrays (FPGAs), application-specific integrated circuits (ASICs), which may include circuits in combination with firmware. Hardware accelerators take advantage of sparse representations of weights and layer outputs of a neural network to achieve significantly faster computational speed and less computational resources compared to dense neural networks that have below a threshold sparsity. Depending on the architecture or the computing environment, a hardware accelerator may impose a particular sparsity constraint for neural networks that specify how the zero values should be structured within the set of weights or layer outputs of the neural networks.

Thus, in one embodiment, the inference system 104 receives a request to train the sparse neural network subject to one or more sparsity constraints, such that the inference system 104 can perform inference using the sparse neural network on, e.g., a hardware accelerator. Specifically, a sparsity constraint may specify that weights or layer outputs of a neural network be above a threshold sparsity, or may specify how the pruned, zero values should be spatially distributed within the weights or layer outputs of the neural network. As defined herein, the sparsity can be defined with respect to the ratio of the number of zero elements to the total number of elements in a set or a number of zero elements in a set. A sparsity constraint may cause the weights or layer outputs of a neural network to be above a threshold with respect to the entire elements of the weight tensor or with respect to particular regions of the weight tensor. For example, a sparsity constraint may specify that at least 80% of elements in each row of a sparse weight tensor be zero values. As another example, a sparsity constraint may specify that at least 70% of elements in each group of ten columns of a weight tensor be zero values.

### High-Level Overview of Training Process and Pruning of a Sparse Neural Network

During the training process, the inference system 104 initializes the architecture for a neural network and determines a set of initial connections between layers of the neural network associated with an estimated set of weights. The inference system 104 propagates training input data through the neural network to generate an estimated output. Specifically, outputs for a current layer are generated by applying the set of estimated weights for the current layer to a layer output of a previous layer. In one embodiment, the set of weights for one or more layers are modeled as random variables sampled from probability distributions. The inference system 104 determines a loss function and updates the probability distributions for the set of weights by backpropagating error terms obtained from the loss function. This process is repeated until convergence criteria is reached.

After the training process, the inference system 104 prunes one or more subsets of weights based on their signal-to-noise ratios (SNRs). Specifically, the SNR for a weight indicates how valuable the weight is to performing inference of the neural network. In other words, the inference system 104 prunes one or more subsets of weights that are estimated to have relatively low contributions to the inference accuracy of the neural network as indicated by their SNR values. The selected weights are modified to zero values in the weight tensor to satisfy one or more sparsity constraints. This is equivalent to removing or pruning connections in the neural network corresponding to these selected weights. Thus, a weight may have a zero value if there was no initial connection in the architecture to begin with or if it was pruned after the training process. The values for the remaining, non-pruned weights may be inferred from the resulting probability distributions for these weights to generate the weight tensor for each layer.

In one instance, the weights for a neural network during the training process are modeled as Gaussian random variables each sampled from a respective Gaussian distribution with two parameters, a mean and a variance. In such a case, the SNR of a weight may be defined as the ratio between the mean of the Gaussian distribution for the weight to the variance or standard deviation of the Gaussian distribution. The SNR compares the level of a signal (e.g., mean) to the level of background noise (e.g., variance) of a weight. Thus, pruning a weight with a low SNR (i.e., noisy weight) will not significantly impact the inference accuracy of the neural network, and the inference system 104 may prune subsets of weights having SNR values below a threshold to control the sparsity of the neural network. In one instance, the values for the non-pruned weights may be determined as the mean values of the Gaussian distributions for these weights.

In one embodiment, a sparsity constraint may specify that sub-volumes of weights or layer outputs of a neural network be pruned together. In such an embodiment, the inference system 104 partitions the weight tensor into sub-volumes of weights and selects one or more sub-volumes to prune after the training process. In such an embodiment, elements within each selected sub-volume are modified to zero values together. A sparsity constraint may specify that at least a threshold number of sub-volumes are pruned with respect to entire elements of the weight tensor or with respect to particular regions of the weight tensor, such that the sparsity for the weights or layer outputs are above a threshold. In one instance, the sub-volumes of weights are blocks of contiguous weights within a the weight tensor. For example, a weight tensor may be partitioned into 4×4 submatrices of elements, and the inference system 104 may select one or more blocks for pruning such that at least two blocks in each row of blocks of the weight tensor are modified to zero values.

Training a neural network to have sparse sub-volumes of weights or layer outputs is advantageous, among other reasons, because hardware implementations of a neural network often perform computation on a tensor with respect to sub-volumes of elements, rather than the entire weight tensor at once. The sparsity constraints imposed by such hardware often involve setting each of these sub-volumes to zero values together, rather than setting individual elements. For example, a sparsity constraint for a hardware accelerator may specify that two or more blocks within each row of blocks of a weight tensor be zero values. Responsive to receiving a request, the inference system 104 can train a sparse neural network with weights or layer outputs that satisfy such sparsity constraints, such that the neural network can be executed on the hardware in a computationally efficient manner.

In one embodiment, the weights for a current layer of a neural network during the training process are modeled as a product between a scalar tensor and random variables sampled from probability distributions defined by one or more parameter tensors. Specifically, elements of the scalar tensor and the one or more parameter tensors each correspond to a respective weight for the current layer. Thus, the scalar tensor and the one or more parameter tensors may have same dimensionality as a weight tensor, and a weight can be represented as a product between a scalar value at a respective location in the scalar tensor and a random variable sampled from a probability distribution defined by one or more parameters at the respective locations in the one or more parameter tensors. In one instance, when the weights are modeled as Gaussian random variables, the one or more parameter tensors include a first parameter tensor representing the means of the Gaussian distributions and a second parameter tensor representing the variances or standard deviations of the Gaussian distributions.

In one embodiment, when the weights of a neural network are pruned on a sub-volume basis, the weights for a current layer are modeled such that weights within each sub-volume share a common random variable sampled from a probability distribution defined by the one or more parameter tensors. In one instance, this is implemented by partitioning each parameter tensor into sub-volumes of elements that correspond to the sub-volumes of weights and configuring the parameter values for these sub-volumes to a common value during the training process. The inference system 104 determines a loss function and updates the scalar tensor and the one or more parameter tensors to update the probability distributions of the random variables. The inference system 104 determines the SNR for the sub-volumes of weights based on the parameter tensors and selects one or more sub-volumes of weights for pruning based on the determined SNR. Since the parameter values for each sub-volume of weights were held to a common value during the training process, weights within each sub-volume may be associated with the same SNR and be pruned together.

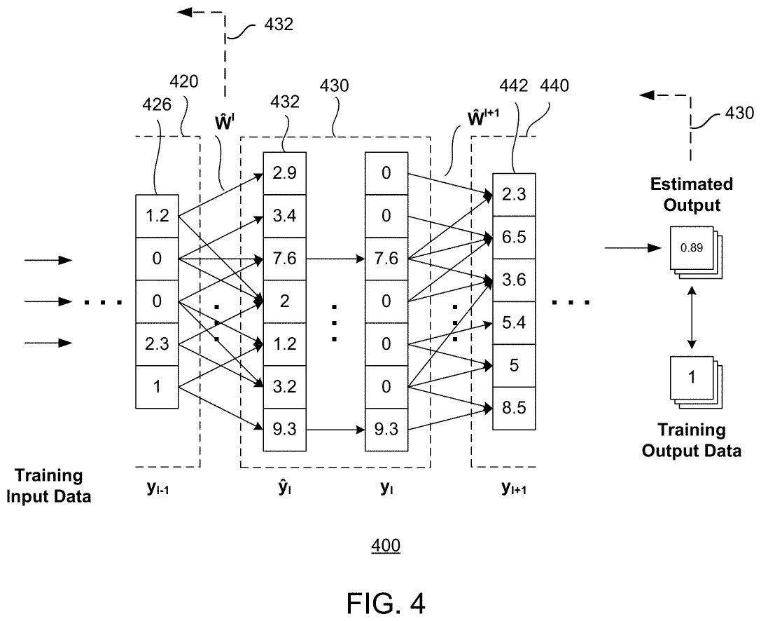

As described in more detail below in conjunction with the training process shown in FIG. 4, modeling the weights as a product between a scalar tensor and random variables sampled from probability distributions enables efficient training of a neural network by modeling the weights as random variables and adding noise to the layer output. Specifically, training a neural network, especially one with many layers and nodes, would be very slow even on modern hardware like graphical processing units (GPUs) because the weights would have to be resampled for each iteration. Moreover, other methods of modeling weights as random variables may not allow pruning of arbitrary sub-volumes of weights, leading to significantly less flexibility in controlling sparsity for neural networks.

### Detailed Architecture and Inference Process of a Sparse Neural Network

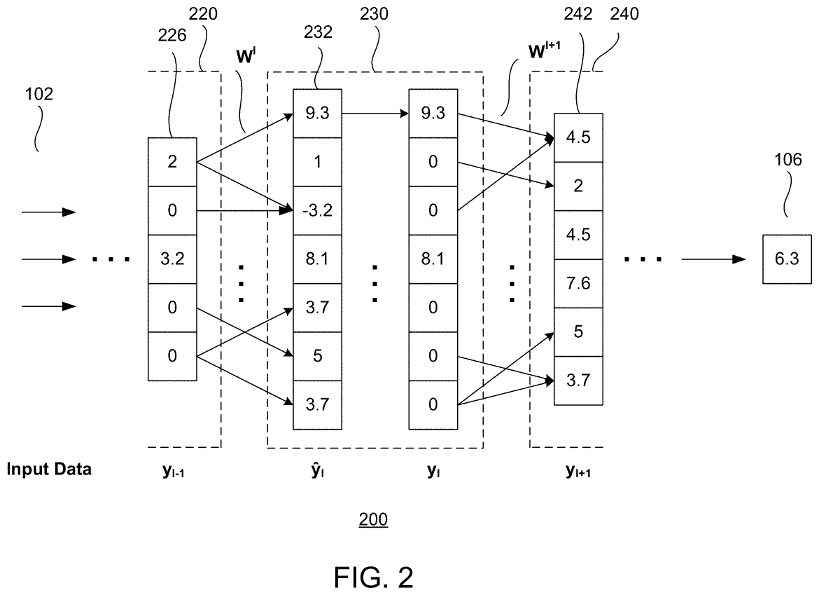

FIG. 2 illustrates an example architecture of a sparse neural network 200, according to an embodiment. The sparse neural network 200 shown in FIG. 2 may include one or more sets of sparse weights that were trained and pruned. The architecture of the sparse neural network 200 includes a set of layers l=1, 2, . . . , n, each including at least one node. For example, the sparse neural network 200 includes, among other layers, a l−1-th layer 220 including five nodes 226, a l-th layer 230 including seven nodes 232, and a l+1-th layer 240 including six nodes 242. While the layers 220, 230 in FIG. 2 are illustrated as hidden layers placed between an input layer that receives the input data and an output layer that generates the inference data, it is appreciated that any one of the layers may be the input layer or the output layer.

The sparse neural network 200 also includes a set of weight tensors W^{l}, l=1, 2, . . . , n associated with each layer that are determined through the training process performed by the inference system 104. Each connection between a pair of nodes in FIG. 2 may indicate a non-pruned weight in the respective weight tensor, for which a weight value was determined from its probability distribution after training. For example, the connections between nodes of the l-th layer 230 and nodes of the previous l−1-th layer 220 are associated with non-pruned weights in the weight tensor W^{l} for the l-th layer 230. Similarly, the connections between nodes of the l+1-th layer 240 and nodes of the previous l-th layer 230 are associated with non-pruned weights in the weight tensor W^{l+1} for the l+1-th layer 240. The remaining elements in the weight tensor may be zero values.

The sparse neural network 200 may be trained and pruned subject to one or more sparsity constraints, as described in conjunction with the inference system 104 in FIG. 1. For example, the set of weights for one or more layers of the sparse neural network may be subject to a sparsity constraint that requires the sparsity of the weights to be equal to or greater than a first threshold with respect to the total number of elements in the weight tensor or with respect to particular regions of the weight tensor. For example, in the sparse neural network 200 shown in FIG. 2, the sparsity for the set of weights W^{l} may be determined with respect to the ratio of the number of zero connections to the total number of connections (i.e., total number of elements in weight tensor W^{l}) between layer 230 and layer 220. The total number of possible connections is 7 nodes×5 nodes=35 possible connections, and since there are 6 non-pruned connections, the sparsity may be computed as (35-6)/35=83%. In one instance, a set of sparse weights may have a sparsity equal to or greater than 0.30. In another instance, the sparsity may be equal to or greater than 0.70 or may be equal to or greater than 0.90.

As another example, the weights for one or more layers of a sparse neural network may be subject to a sparsity constraint that requires that each individual node in a layer be associated with a fixed number of non-zero weights. For example, in the sparse neural network 200 shown in FIG. 2, every node in the l-th layer 230 may be associated with a fixed number of two, non-pruned connections. Fixing the number of non-zero connections for each node results in a fixed number of matrix operations (e.g., multiplications) and may significantly improve the computational speed and computational efficiency when, for example, the sparse neural network is implemented on hardware, such as FPGA's.

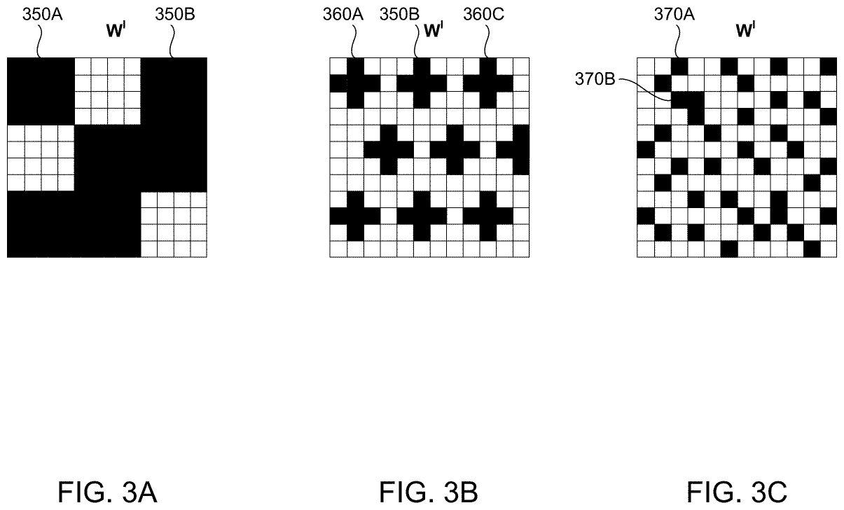

FIGS. 3A-3C illustrate examples of weight tensors for the sparse neural network 200, according to embodiments. The example weight tensors in FIGS. 3A-3C are two-dimensional weight tensors and may visually represent examples of a set of sparse, pruned weights for the l-th layer 230 of the sparse neural network 200, each subject to a different example sparsity constraint. In particular, each white element represents a non-pruned weight, and each black square may represent a pruned weight that is a zero value in the weight tensor.

FIG. 3A illustrates a weight tensor W^{l} subject to a sparsity constraint that imposes pruning on a block-by-block basis and at least two blocks for each row of blocks in the weight tensor be zero values. Specifically, the sub-volumes in FIG. 3A are 4×4 blocks of elements, or 4×4 sub-matrices of elements within the weight tensor. The set of weights are partitioned into blocks, and at least two blocks from each row of blocks that have SNR values below a threshold value or proportion are selected for pruning. For example, in the first row of blocks, two blocks, 350A and 350B, are zeroed-out to satisfy the sparsity constraint for the first row.

FIG. 3B illustrates a weight tensor subject to a sparsity constraint that imposes pruning on a sub-volume basis and at least 30% of the elements in the weight tensor be zero values. Specifically, the sub-volumes in FIG. 3B are contiguous subsets of elements with a “+” shape within the weight tensor. The set of weights are partitioned into “+” shaped sub-volumes, and at least nine sub-volumes from the set of weights that have SNR values below a threshold value or proportion are selected for pruning, including sub-volumes 360A, 360B, and 360C, to satisfy the sparsity constraint. As shown in FIG. 3B, the method described herein may allow the inference system 104 to prune sub-volumes of weights with arbitrary shapes and sizes that are not, for example, limited to blocks or sub-matrices of elements.

FIG. 3C illustrates a weight tensor subject to a sparsity constraint that at least two elements in each column of the weight tensor be zero values. Different from the example weight tensors shown in FIGS. 3A and 3B, the weight tensor in FIG. 3C may be pruned on an individual element-by-element basis. At least two elements from each column that have SNR values below a threshold value or proportion are selected for pruning. For example, in the third column of the weight tensor, two elements, 370A and 370B, are zeroed out to satisfy the sparsity constraint for the third column.

While the set of weights shown in FIGS. 3A-3C are illustrated as two-dimensional tensors, the examples are provided merely to facilitate explanation. It should be appreciated that the set of weights for a layer of the neural network 200 can be represented as multi-dimensional tensors having higher dimensionality than 2-D tensors. For example, when the set of weights are represented as a 3-D weight tensor (as in the case of convolutional neural networks), the sub-volumes of weights may correspond to 3-D sub-tensors within the weight tensor that are pruned together during the pruning process.

Returning to FIG. 2, during the inference process, the input data 102 is propagated through the sparse neural network 200 starting from the first layer, to generate layer outputs y^{l}, l=1, 2, . . . , n, and eventually, the inference data 106. Specifically, a current layer receives the layer output of nodes at a previous layer and generates an intermediate output by applying the set of weights for the current layer to the layer output of the previous layer. For example, in the sparse neural network 200 of FIG. 2, the l-th layer 230 receives the layer output yₗ₋₁ of the five nodes at the previous l−1-th layer 220, and generates an intermediate output ŷₗ by applying the set of weights W^{l} to the layer output yₗ₋₁ of the previous layer. The current layer may further generate the layer output by processing the intermediate outputs through an activation function gₗ(·) for the layer. In one instance, the activation function may be a rectified linear unit (ReLU) function applied to the intermediate output of each node. For example, in FIG. 2, the l-th layer 230 further generates the layer output yₗ by applying the ReLU activation function to the intermediate output ŷₗ of each node.

In one embodiment, the sparse neural network 200 may be also configured to include one or more layers that generate sparse layer outputs. In particular, a sparsity constraint may require that the layer outputs be above a threshold with respect to the entire nodes of the layer or with respect to particular subgroups of nodes within the layer. For example, a sparsity constraint may specify that the ratio of the number of nodes with zero values to the total number of nodes in a current layer be at least above a second threshold (e.g., 80%). A sparse layer output may be generated by selecting a subset of nodes based on the values of their intermediate outputs and zeroing the remaining subset of nodes in the current layer. In one instance, the selected subset of nodes are nodes having intermediate outputs above a threshold value or a threshold proportion within all nodes of the current layer.

For example, in the sparse neural network 200 shown in FIG. 2, after generating the set of intermediate outputs, the l-th layer 230 further generates sparse layer outputs yₗ by selecting a subset of nodes having intermediate outputs ŷₗ above a threshold value of 8.0, and zeroing the remaining nodes in the layer 230. In particular, since the first node and the fourth node are associated with intermediate outputs above 8.0, the values for the subset of nodes are selected, and the intermediate outputs for the remaining subset of nodes are zeroed to generate the sparse layer output yₗ. The sparsity of the layer output for the l-th layer 230 may be determined as the ratio of the number of zero values in layer 230 to the number of nodes in layer 330, which is 5 nodes/7 nodes˜0.71. In one instance, a sparse layer output may have a sparsity equal to or greater than 0.80. In other instances, the sparsity may be equal to or greater than 0.90.

In other instances, a sparsity constraint may require that the sparsity of the layer output within each subgroup of nodes is equal to or greater than a second threshold. The inference system 104 selects a subset of nodes within each subgroup of nodes and zeroes the remaining subset of nodes. As an example, a subset of nodes may be selected within each subgroup that have intermediate outputs above a threshold value or threshold proportion within that subgroup. The sparsity may be determined as the ratio of the number of zero values to the number of nodes in a subgroup, and the sparsity for each of these subgroups may be equal to or greater than a second threshold.

For example, in the sparse neural network shown in FIG. 2, the sparsity of the layer output of the l-th layer 230 may be determined with respect to two subgroups nodes in the layer 230, the first subgroup including first to fourth nodes, and the second subgroup including fifth to seventh nodes. For example, one node with the highest intermediate output may be selected within each subgroup for high sparsity. Thus, the first node within the first subgroup, and the seventh node within the second subgroup are selected, and the values for the remaining subset of nodes are zeroed to generate the sparse layer output yₗ. The sparsity for a subgroup may be determined as the ratio of the number of zero values to the number of nodes in the subgroup, and the sparsity for each of these subgroups may be equal to or above a second threshold.

In another instance, a sparsity constraint may require that each layer be associated with a fixed number of non-zero values. For example, a fixed subset of nodes in each layer may be selected based on their intermediate values (e.g., fixed subset of nodes with highest intermediate values), and the remaining subset may be zero values. For example, in FIG. 2, the l-th layer 230 may generate a sparse layer output with a fixed number of three non-zero values to improve computational speed and efficiency when the neural network is implemented on hardware. As another example, a fixed subset of nodes may be selected from each subgroup of nodes based on their intermediate values (e.g., fixed subset of nodes within the subgroup with highest intermediate values), such that each subgroup has the same number of non-zero nodes, and the remaining subset in each subgroup may be zero values.

All or a subset of layers of the sparse neural network 200 may generate sparse layer outputs, or have connections with a set of sparse weights. For example, the sparse neural network 200 may include a subset of layers that generate sparse layer outputs, and a remaining subset of layers that generate relatively dense layer outputs. Similarly, the sparse neural network may include a subset of layers each associated with a set of sparse weights that were trained and pruned by the inference system 104, and a remaining set of layers associated with relatively dense set of weights. Moreover, while a given layer may have the combination of sparse layer outputs and sparse weights, a layer may only generate sparse layer outputs, or only have a sparse set of weights.

In addition, the description of sparse weights and sparse layer outputs in FIG. 2 have been described with respect to a feed forward architecture in which nodes of a current layer are connected to nodes of a previous layer that is spatially placed immediately before the current layer in FIG. 2, However, in other embodiments, the sparse neural network 200 described in conjunction with FIG. 2 can be applied to any type of neural network including one or more layers of nodes, and include connections between nodes of layers represented by a set of weights.

For example, in recurrent neural networks, including long short-term memory (LSTM) architectures, a current layer of nodes may be connected to a previous layer that represents the same layer of nodes but temporally placed at a previous time. The set of weights representing these connections may also be trained and pruned according to one or more sparsity constraints, and sparse layer outputs may be generated for the layer of nodes such that the sparsity is above a threshold value or proportion at one or more time steps when executing the recurrent neural network. As another example, in residual neural networks, a current layer of nodes are connected to multiple previous layers, such as a first previous layer placed immediately before the layer, and a second previous layer placed before the first previous layer. The set of weights representing both types of connections may be trained and pruned according to one or more sparsity constraints such that the sparsity is equal to or above a first threshold.

### Detailed Training Process and Pruning of a Sparse Neural Network

FIG. 4 illustrates an example process for training a sparse neural network, according to an embodiment. In particular, FIG. 4 may illustrate a process for training the sparse neural network 200 shown in FIG. 2 at one training iteration. Thus, the architecture of the neural network in FIG. 4 is substantially similar to that shown in FIG. 2, except that the weights have not been trained and pruned to a final form. Among other layers, the neural network architecture 400 includes a l−1-th layer 420 including five nodes 426, a l-th layer 430 including seven nodes 432, and a l−1-th layer 440 including six nodes 442.

The inference system 104 trains the weights of the sparse neural network using a set of training data. The training data includes multiple instances of training input data and training inference data. The training inference data contains known instances of inference data that represent the type of data that the neural network is targeted to predict from the corresponding target input data. For example, the neural network may predict whether an image contains a pedestrian. The training input data may contain multiple images from different scenes, and the corresponding training inference data may contain known labels indicating whether a pedestrian was included in these images. The weights of the sparse neural network are trained to reduce a difference between training inference data and estimated inference data that is generated by propagating the training input data through the neural network.

The inference system 104 may receive requests from one or more user devices to train a sparse neural network subject to sparsity constraints. The request may additionally specify the architecture of the neural network, such as the number of layers and nodes in each layer, as well as which layers a node in a particular layer can have connections to. The inference system 104 starts the training process by initializing the architecture of the neural network 400. For each layer, the inference system 104 also identifies a set of weights that will participate in the training process. That is, the identified set of weights represent initial connections between layers of the neural network, for which one or more subsets may be pruned after the training process is completed. Thus, the number of initial connections may be larger than the number of non-pruned weights as specified by a sparsity constraint. As shown in FIG. 4, the initial connections shown in neural network 400 are relatively dense compared to the pruned set of connections in the sparse neural network in FIG. 2, since the training process has not been completed and the weights have not been pruned.

In one embodiment, the set of weights, as represented by a weight tensor, are modeled as random variables. Specifically, the set of weights are modeled as a product between a scalar tensor and random variables sampled from probability distributions defined by one or more parameter tensors. Thus, the inference system 104 generates and initializes a scalar tensor and one or more parameter tensors that have the same dimensionality as a weight tensor. Throughout the training process, a weight can be represented as a product between a scalar value at a respective location in the scalar tensor and a random variable sampled from a probability distribution defined by one or more parameter values at the respective location in the one or more parameter tensors. In one embodiment referred throughout the specification, the random variables multiplied by the scalar tensor are Gaussian random variables, and thus, the weights themselves are modeled as Gaussian random variables. In such an embodiment, the parameter tensors include a first parameter tensor representing the means and a second parameter tensor representing the variances or standard deviations of the Gaussian distributions for the random variables.

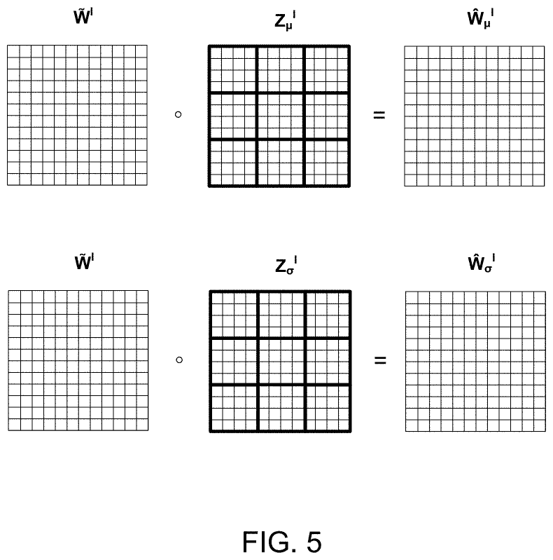

FIG. 5 illustrates generating one or more weight parameter tensors as a product between a scalar tensor and one or more parameter tensors, according to an embodiment. In one embodiment, the scalar tensor and the one or more parameter tensors are used to generate one or more weight parameter tensors throughout the training process. The weight parameter tensors define the probability distributions of the weights. Specifically, a weight parameter tensor is generated by taking a product between the scalar tensor and a respective parameter tensor.

In one instance, the one or more weight parameter tensors include a first weight parameter tensor Ŵ_{μ} that represents the means of the Gaussian distributions and a second weight parameter tensor Ŵ_{σ} that represents the variances or standard deviations of the Gaussian distributions of the weights. These are generated by:

Ŵ_{μ}=\tilde{W}·Z_{μ} (1)

Ŵ_{σ}=\tilde{W}·Z_{σ} (2)

where for a given layer, \tilde{W} is the scalar tensor, Z_{μ} is the first parameter tensor that represents the means of the Gaussian distributions and Z_{σ} is the second parameter tensor that represents the variances or standard deviations of the Gaussian distributions for the random variables, and “·” represents the Hadamard product between tensors. In particular, FIG. 5 illustrates generating weight parameter tensors for a l-th layer 430 of the neural network 400.

In one embodiment, when the weights of a neural network are pruned on a sub-volume basis, the set of weights for a current layer are modeled such that each sub-volume of weights share a common random variable defined by the one or more parameter tensors. Specifically, the inference system 104 partitions each parameter tensor into sub-volumes of elements that correspond to the sub-volumes of weights. The elements for each sub-volume in a parameter tensor share a common value during the training process. As an example, the l-th layer 430 of the neural network 400 may be subject to pruning on a block-by-block basis, where each block is a non-overlapping 4×4 submatrix within the dimensionality of the weight tensor. As shown in FIG. 5, the inference system 104 partitions each of the first parameter tensor Z_{μ}^{l} and the second parameter tensor Z_{σ}^{l} for the l-th layer 430 into 4×4 submatrices (as shown by the bold lines in FIG. 5), and elements within a sub-volume of a parameter tensor share a common value throughout the training process. In this way, weights within the respective sub-volume are modeled as a product between the sub-volume of elements within the scalar tensor and random variables sampled from the same probability distribution that are defined by the common parameters for the sub-volume of elements in the one or more parameter tensors.

Returning to FIG. 4, the inference system 104 trains the set of weights for the neural network 400 by repeatedly iterating between a forward pass step and a backpropagation step. During the forward pass step, the inference system 104 propagates the training input data through the neural network 400 to generate an estimated output at the output layer of the neural network 400. Specifically, layer outputs for a current layer are generated by applying the set of estimated weights for the current layer to a layer output of a previous layer, and this process is repeated for other layers until an estimated output is generated for the neural network 400.

In one instance, the layer outputs for a current layer l are generated by generating the weight parameter tensors for the training iteration. The inference system 104 samples a noise variable ε from a probability distribution defined by:

ε˜ [symbol] (μ=0,σ=1). (3)

After, the inference system 104 generates an estimated weight tensor by:

Ŵ^{l}=Ŵ_{μ}^{l}+Ŵ_{σ}^{l}·ε (4)

The inference system 104 generates the layer outputs for the current layer by:

y^{l}=Ŵ^{l}X (5)

where X indicates the layer outputs of the previous layer l−1. In one example, equations (3)-(5) can be used to generate intermediate outputs for the neural network 400, and the layer outputs can be generated by applying an activation function to the intermediate outputs or modifying one or more elements to generate sparse layer outputs.

In another instance, the layer outputs for a current layer l are generated by generating the weight parameter tensors for the training iteration. The inference system 104 samples a noise variable c from a probability distribution defined by:

ε˜ [symbol] (μ=0,σ=1). (6)

After, the inference system 104 generates a first layer output parameter by:

y_{μ}^{l}=Ŵ_{μ}^{l}X, (7)

And a second layer output parameter by:

y_{σ}^{l}=\sqrt{(Ŵ_{σ}^{l}X)²} (8)

where X indicates the layer outputs of the previous layer l−1. The inference system 104 generates the layer outputs for the current layer by:

y^{l}=y_{μ}^{l}+y_{σ}^{l}·ε. (9)

Similarly, equations (6)-(9) can be used to generate intermediate outputs for the neural network 400, and the layer outputs can be generated by applying an activation function to the intermediate outputs or modifying one or more elements to generate sparse layer outputs. By modeling the weights as a product between a scalar tensor and random variables sampled from probability distributions enables efficient training of a neural network by adding noise to the layer output.

The method of generating the layer outputs for a given layer as described with reference to equations (3)-(9) enables layer outputs to be generated by modeling the set of weights for the current layer as random variables. However, the layer outputs can be generated during the forward pass step using any method that enables the a set of weights to be modeled as random variables, and applied to layer outputs of a previous layer or any other layer the weights have connections to.

Also as discussed above in conjunction with FIG. 2, each layer in the one or more layers of the neural network 400 may generate sparse layer outputs. Thus, during the forward pass step for a training iteration, a current layer may generate sparse layer outputs based on values of nodes generated by propagating the training data for the iteration through the sparse neural network. For example, a current layer may generate intermediate layer outputs by applying the set of weights for the iteration to layer outputs of the previous layer. The current layer may further generate sparse layer outputs by selecting a subset of nodes having intermediate outputs above a threshold for that iteration. This process may be repeated for subsequent iterations, and different subsets of nodes may be selected at different iterations depending on the training data and the updated values of the weights.

After performing the forward pass step for a training iteration, the inference system 104 determines a loss function. inference system 104 trains the sparse neural network by reducing a loss function. In one embodiment, the loss function includes a combination of a first loss 430 that is a reconstruction loss and a second loss 432 that is a complexity loss. The first reconstruction loss 430 indicates a difference between training inference data and estimated inference data that is generated by propagating the respective training input data through the architecture. The second complexity loss 432 indicates the information content in the set of weights of the neural network 400. The second complexity loss 432 may be given as a combination of the information content in the set of weights across the set of layers for the neural network 400.

During the backpropagation step for the training iteration, the inference system 104 backpropagates one or more error terms obtained from the loss function to update the set of weights for the neural network 400 to reduce the loss function. In particular, the inference system 104 obtains gradients with respect to the scalar tensor and the one or more parameter tensors to update values for these tensors to reduce the loss function. This process is repeated for multiple training iterations until a convergence criterion is reached.

By reducing the loss function including the combination of the first reconstruction loss 430 and the second complexity loss 432, the probability distributions of the weights of the neural network 400 are updated through the scalar tensor and the one or more parameter tensors such that high information content is used only when necessary to achieve high reconstruction accuracy between the estimated inference data and training inference data. Thus, weights that represent connections valuable for the inference accuracy of the neural network 400 will have higher information content than those that do not.

In one instance, the first reconstruction loss is given by:

$${l}_{R} ( {y}_{e}^{n} , {y}^{n} ) = {\sum }_{t = 1}^{T} ( {‖ {y}_{e}^{n} - {y}^{n} ‖}_{2}^{2} ) \qquad ( 10 )$$

where yⁿ is the training inference data for data instance t and yₑⁿ is a corresponding estimated inference data generating during the forward pass step, and T is the total number of data instances in the training data for the current training iteration. However, equation (10) is merely an example of a reconstruction loss, and in practice, any type of loss that measures the discrepancy between the training inference data and the estimated inference data can be used. For example, the reconstruction loss may also be a L1 norm, a L∞ norm, a sigmoid function, and the like.

In one instance, the second complexity loss for a weight is given by:

[symbol]

_{C}=−k₁×Sigmoid(k₂+k₃×log w_{α})+0.5×Softplus(−log w_{α})+k₁ (10)

Where in one instance, k₁=0.63576, k₂=1.8732, k₃=1.48695, and where w_{α}=w_{σ}²/w_{μ}², or the inverse of the SNR of the weight when the weight is modeled as a Gaussian variable. In particular, w_{σ} may be obtained from the element of the second parameter tensor at the respective location for the weight, and similarly, w_{μ} may be obtained from the element of the first parameter tensor at the respective location of the weight. Equation (10) indicates the approximate number of bits of information in the weight.

In another instance, the second complexity loss for a weight is given by:

[symbol]

_{C}=λ×w_{SNR} (11)

where w_{SNR}=w_{μ}²/w_{σ}², or the SNR of the weight and k represents a scalar value that adjusts the relative weighting of the complexity loss relative to the reconstruction loss. For instance, a high X allows the loss function to weight the complexity loss at higher proportions compared to the reconstruction loss, while a low X allows the loss function to weight the complexity loss at lower proportions compared to the reconstruction loss. In another instance, the second complexity loss for the weight is given by:

[symbol]

_{C}=λ×log w_{SNR}. (12)

Since the SNR of a weight is the signal-to-noise ratio of the weight when the weight is modeled as a random variable sampled from a probability distribution, the SNR of the weight indicates the weight's information content and thus, the degree of contribution a weight makes in generating the inference data for the neural network 400. By formulating the second complexity loss with respect to the SNR of the weight, the neural network 400 reduces the reconstruction error while reducing the information content for the set of weights, such that important weights that contribute to the inference accuracy of the neural network 400 end up with the highest information content.

Further, formulating the second complexity loss with respect to the SNR of a weight is advantageous, among other reasons, because it reduces the computational cost of training the neural network 400. Specifically, while the neural network 400 can be trained with a second complexity loss represented by other functions, such as the Kullback-Leibler (KL) divergence, this requires considerable computational cost when training the neural network 400 since these functions are to be computed for every weight in the neural network 400 (often millions or even hundreds of billions of weights) for each training iteration. On the other hand, computing the SNR of the weight reduces the cost and run-time of each training iteration.

Moreover, equations (11)-(12) are merely examples of computing the second complexity loss with respect to the SNR's of the weights. In other embodiments, the second complexity loss may be any function of the SNR of a weight that monotonically changes with the SNR of the weight.

After the training process is completed, the inference system 104 prunes one or more subsets of weights based on the resulting probability distributions of the weights based on sparsity constraints. The probability distributions for the weights are defined by the trained values of the scalar tensor and the one or more parameter tensors. In one embodiment, the inference system 104 computes the SNR of the weights for a current layer of the neural network 400 and orders the weights according to their SNR values. In one instance, the SNR of the set of weights is given by W_{μ}²/W_{σ}² or a function thereof, where W_{μ}² is the first weight parameter tensor and W_{σ}² is the second weight parameter tensor. The inference system 104 may select a subset of weights with SNR values below a threshold value or a threshold proportion (e.g., bottom 10%, 20%, or 30% among weights for the current layer) for pruning according to sparsity constraints.

In another embodiment, the inference system 104 computes the SNR's of the random variables of the weights for a current layer of the neural network 400 as indicated by the one or more parameter tensors, and orders the weights according to the SNR values of the respective random variables. In one instance, the SNR values of the random variables is given by Z_{μ}²/Z_{σ}² or a function thereof, where Z_{μ}² is the first parameter tensor and Z_{σ}² is the second parameter tensor. The inference system 104 may select a subset of weights with random variables having SNR values below a threshold value or a threshold proportion for pruning.

As described above in conjunction with FIGS. 4-5, when the set of weights are pruned on a sub-volume basis, each partitioned sub-volume of elements in the one or more parameter tensors share a common value. Thus, each sub-volume of weights is associated with the same SNR value for a respective random variable. In such an embodiment, the inference system 104 computes the SNRs of the random variables for each partitioned sub-volume of elements and orders the sub-volumes of weights according to the computed SNR values. In one instance, the SNR values of a random variable for a sub-volume is given by Z_{μ}^{subvolume 2}/Z_{σ}^{subvolume 2}, where Z_{μ}^{subvolume 2} is the value for the first parameter and Z_{σ}^{subvolume 2} is the value for the second parameter of the random variable. The inference system 104 then selects a subset of sub-volumes with SNR values below a threshold value or a threshold proportion for pruning.

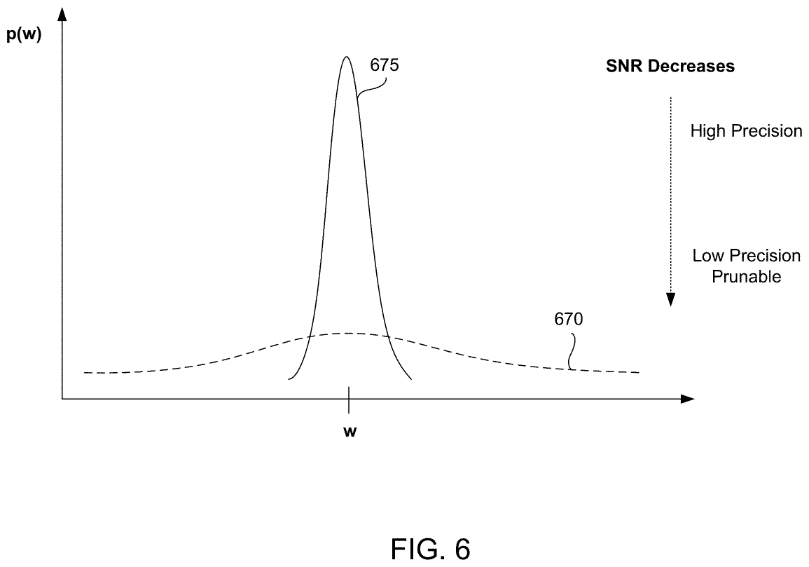

FIG. 6 is a graph illustrating signal-to-noise ratio (SNR) for a weight modeled as a random variable sampled from a probability distribution, according to an embodiment. The x-axis (horizontal axis) represents potential values of the weight w, and the y-axis (vertical axis) represents the likelihood or probability of the weight as defined by the weight's probability distribution. Specifically, FIG. 6 illustrates two example probability distributions 670, 675 for a weight in the neural network modeled as a random variable. The weight is modeled as a Gaussian random variable. In particular, when the SNR is defined as the ratio between the mean to the variance or standard deviation of the Gaussian distribution, the probability distribution 670 is associated with a low SNR (e.g., high variance), and the probability distribution 675 is associated with a high SNR (e.g., low variance).

As shown in FIG. 6, as the SNR decreases, the Gaussian distribution 670 becomes wider due to higher variance or noise. If the SNR of the weight is sufficiently low, the weight can be interpreted as a noisy random variable and it can be pruned without significantly affecting the inference accuracy of the neural network. Moreover, the concept of pruning for low-SNR weights can be extended to quantization, since sparsity and quantization are on a similar spectrum with respect to the amount of information contained in the weight. If the SNR of the weight is sufficiently low, the weight also becomes more quantizable, and thus, the layer outputs to nodes that the weight is connected to is also more quantizable. The method of training the neural network described herein promotes both sparsity and quantizability, two properties that are important for hardware but are conventionally treated as separate.

Returning to FIG. 4, after the selected weights are pruned, the inference system 104 generates the weight tensor for the one or more layers of the neural network 400. Specifically, weights that were selected for pruning or were not associated with connections are set to zero values in the weight tensor. The values of the remaining, non-pruned weights in the weight tensor may be determined from the resulting probability distributions of these weights that were learned during the training process. In one instance, the values for the non-pruned weights in the weight tensor are the means of the Gaussian distributions for the weights. However, in other embodiments, the values for the non-pruned weights may be determined based on any other type of statistic of the probability distributions for the weights.

The inference system 104 may determine the weight tensors for the one or more layers of the neural network, and provide the trained and pruned sparse neural network 400 to the client device of the request such that the sparse neural network can be deployed to perform a set of inference tasks. In particular, since the neural network was trained and pruned subject to the requested sparsity constraints, the neural network may be deployed and executed on appropriate hardware in an efficient manner. In other embodiments, the inference system 104 or some part of the inference system 104 may also be responsible for deploying and executing the sparse neural network instead of a separate entity.

### Method of Training a Sparse Neural Network

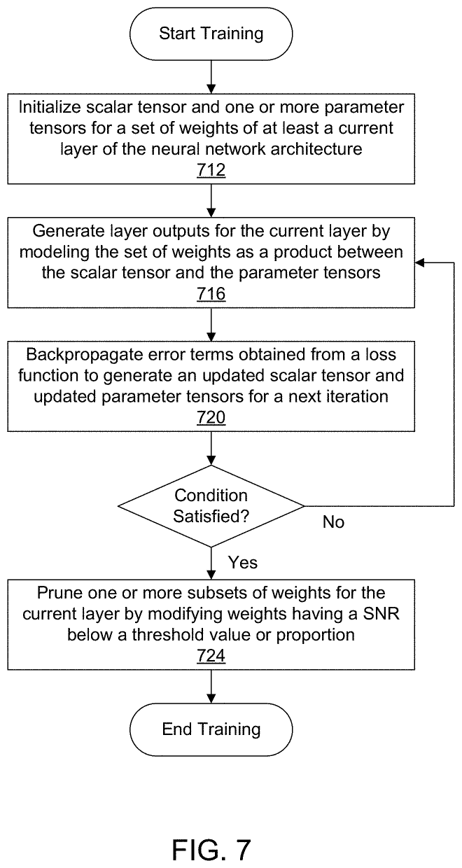

FIG. 7 is a flowchart illustrating a method of training a sparse neural network, according to one embodiment. The inference system 104 initializes 712 a scalar tensor and one or more parameter tensors for a set of weights of at least a current layer of the neural network architecture. Each parameter tensor is partitioned into subsets of elements, where elements of each subset sharing a common value for a respective parameter of a probability distribution.

For one or more sequential iterations, the inference system 104 performs the steps of (a) generating 716 layer outputs for the current layer by modeling the set of weights for a current training iteration of the current layer as a product between the scalar tensor and random variables sampled from the probability distributions defined by the one or more parameter tensors, and (b) backpropagating 720 error terms obtained from a loss function to generate an updated scalar tensor as the scalar tensor and updated parameter tensors as the one or more parameter tensors for a next iteration. The loss function indicates a difference between estimated inference data and training inference data, and a quantity proportional to a signal-to-noise ratio of the set of weights for the current layer. The inference system 104 repeats the next iteration of steps (a) and (b) until one or more conditions are satisfied.

The inference system 104 prunes 724 one or more subsets of weights for the current layer by modifying the one or more subsets of weights having a signal-to-noise ratio below a predetermined threshold value or threshold proportion. In one embodiment, the inference system 104 repeats the process of training weights of the neural network and pruning the weights based on the SNR of the weights one or more times to generate the sparse neural network that can be deployed for various inference tasks. For example, the inference system 104 may train the set of weights for the neural network, and prune a subset of the weights based on their SNRs. In a next iteration, the inference system 104 trains the remaining set of weights and prune a second subset of weights based on their SNRs. This process can be repeated multiple times until the desired sparsity constraint is satisfied for the sparse neural network.

As described in conjunction with FIG. 2, while the training process and pruning of sparse neural networks are described herein with an example feedforward architecture and a set of weights represented by a 2-D weight tensor, it should be appreciated that one the methods described herein also apply to different types of neural network architectures, including recurrent neural networks (RNNs), long short-term memory (LSTM) architectures, convolutional neural networks (CNNs), transformer architectures, and the like. In particular, the training process and pruning of sparse neural networks described herein may be applied and expanded to any set of weights that are connected to one or more layers of a neural network, and may not be limited to weights that are represented as 2-D weight tensors.

### Block Diagram of Computing Device

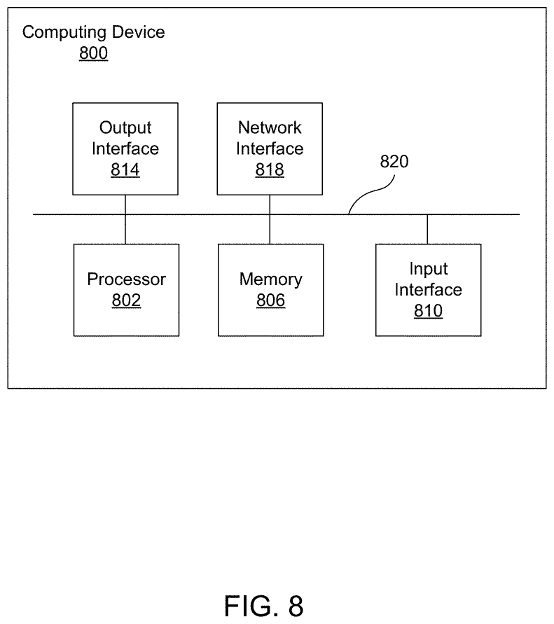

FIG. 8 is a block diagram of a computing device 800 for implementing inference systems according to embodiments. The computing device 800 may include, among other components, a processor 802, a memory 806, an input interface 810, an output interface 814, a network interface 818, and a bus 820 connecting these components. The processor 802 retrieves and executes commands stored in memory 806. The memory 806 store software components including, for example, operating systems and modules for instantiating and executing nodes as described herein. The input interface 810 receives data from external sources such as sensor data or action information. The output interface 814 is a component for providing the result of computation in various forms (e.g., image or audio signals). The network interface 818 enables the computing device 800 to communicate with other computing devices by a network. When multiple nodes or components of a single node is embodied in multiple computing devices, information associated with temporal sequencing, spatial pooling and management of nodes may be communicated between computing devices via the network interface 818.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method for training weights for a neural network architecture, comprising:
initializing a scalar tensor and one or more parameter tensors for a set of weights of at least a current layer of the neural network architecture, each parameter tensor partitioned into subsets of elements, elements of each subset sharing a common value for a respective parameter of a probability distribution;
determining the set of weights for the neural network architecture, comprising:
(a) generating layer outputs for the current layer by modeling the set of weights for a current training iteration of the current layer as a combination between the scalar tensor and random variables sampled from the probability distributions defined by the one or more parameter tensors, and
(b) backpropagating error terms obtained from a loss function to generate an updated scalar tensor as the scalar tensor and updated parameter tensors as the one or more parameter tensors for a next iteration, the loss function indicating a difference between estimated inference data and training inference data, and a value that increases when a signal-to-noise ratio (SNR) of the set of weights for the current layer increases; and
(c) repeating the next iteration of (a) and (b) until one or more conditions are satisfied; and
pruning one or more subsets of weights for the current layer by modifying the one or more subsets of weights having a signal-to-noise ratio below a threshold value or threshold proportion.

2. The method of claim 1, further comprising:
representing the set of weights for the current layer as a weight tensor, and
wherein pruning the one or more subsets of weights further comprises modifying elements at locations of the one or more subsets of weights in the weight tensor to zero values.

3. The method of claim 2, wherein a dimensionality of the scalar tensor and the one or more parameter tensors are the same as a dimensionality of the weight tensor.

4. The method of claim 2, wherein the pruned one or more subsets of weights are shaped as multi-dimensional blocks in the weight tensor.

5. The method of claim 1, wherein random variables for the set of weights are modeled as Gaussian random variables, and the one or more parameter tensors include a first parameter tensor representing means of the random variables and a second parameter tensor representing variances of the random variables.

6. The method of claim 5, wherein generating the layer outputs further comprises:
generating a first weight parameter tensor by taking a product between the scalar tensor and the first parameter tensor, and
generating a second weight parameter tensor by taking a product between the scalar tensor and the second parameter tensor.

7. The method of claim 6, wherein generating the layer outputs further comprises:
generating a first layer output parameter by applying the first weight parameter tensor to layer outputs of a previous layer,
generating a second layer output parameter by applying the second weight parameter tensor to layer outputs of a previous layer, and
combining the first layer output parameter and the second layer output parameter perturbed with a noise variable.

8. The method of claim 6, wherein generating the layer outputs further comprises:
generating an estimated weight tensor by combining the first weight parameter tensor and the second weight parameter tensor perturbed with a noise variable, and
generating the layer outputs by applying the estimated weight tensor to layer outputs of a previous layer.

9. The method of claim 1, further comprising determining values of at least one non-pruned weight as a mean of a probability distribution of the non-pruned weight.

10. The method of claim 9,
wherein random variables for the set of weights are modeled as Gaussian random variables, and the one or more parameter tensors include a first parameter tensor representing means of the random variables and a second parameter tensor representing variances of the random variables, and
wherein the mean of the probability distribution of the non-pruned weight is determined as a product between a respective element for the weight in the scalar tensor and a respective element for the weight in the first parameter tensor.

11. The method of claim 1, further comprising:
receiving, from a client device, one or more sparsity constraints on the set of weights for the neural network architecture, and
wherein the one or more subsets of weights for the current layer are pruned to satisfy the one or more sparsity constraints received from the client device.

12. The method of claim 1, wherein the value that increases when the SNR of the set of weights for the current layer increases is a monotonic function of the SNR of the set of weights for the current layer.

13. A method, comprising:
determining a set of weights of at least a current layer of a neural network architecture, comprising:
(a) generating intermediate outputs for the current layer by modeling the set of weights for the current layer as random variables sampled from probability distributions,
(b) zeroing out a subset of intermediate outputs for the current layer to generate sparse layer outputs,
(c) backpropagating error terms obtained from a loss function to update the set of weights for a next iteration, the loss function including at least a difference between estimated inference data and training inference data, and
(d) repeating the next iteration of (a)-(c) until one or more conditions are satisfied; and
pruning one or more subsets of weights for the current layer by modifying the one or more subsets of weights having a signal-to-noise ratio below a predetermined threshold.

14. The method of claim 13, further comprising:
representing the set of weights for the current layer as a weight tensor, and
wherein pruning the one or more subsets of weights further comprises modifying elements at locations of the one or more subsets of weights in the weight tensor to zero values.

15. The method of claim 14, wherein the pruned one or more subsets of weights are shaped as multi-dimensional blocks in the weight tensor.

16. The method of claim 13, wherein random variables for the set of weights are modeled as Gaussian random variables.

17. The method of claim 16, further comprising determining values of at least one non-pruned weight as a mean of a Gaussian distribution of the non-pruned weight.

18. The method of claim 13, further comprising:
receiving, from a client device, one or more sparsity constraints on the set of weights and the layer outputs for the current layer of the neural network architecture, and
wherein the one or more subsets of weights of the current layer and the intermediate outputs for the current layer are zeroed out to satisfy the one or more sparsity constraints received from the client device.

19. The method of claim 13, wherein the set of weights are modeled as a product between a scalar tensor and random variables sampled from probability distributions defined by one or more parameter tensors.

20. The method of claim 13, a sparsity of the sparse layer outputs is above a predetermined threshold value or proportion.
